(19) United States
(12) Patent Application Publication
(10) Pub. No.: US 2015/0049893 A1
(43) Pub. Date: Feb. 19, 2015

(54) Dynamic Driver In Hearing Instrument

(71) Applicant: Knowles Electronics, LLC, Itasca, IL (US)

(72) Inventors: Joseph Heidenreich, Lake Zurich, IL (US); Evan Llamas-Young, Morgan Hill, CA (US)

(21) Appl. No.: 14/454,281

(22) Filed: Aug. 7, 2014

Related U.S. Application Data
(60) Provisional application No. 61/867,359, filed on Aug. 19, 2013.

(51) Int. Cl. H04R 25/00

(52) U.S. Cl. CPC H04R 25/50; H04R 2460/05
USPC 381/320

(57) ABSTRACT

A hearing instrument includes a first speaker having a first frequency range. The hearing instrument also includes a second speaker that is disposed in the ear of a listener. The second speaker has a second frequency range that is wider than the first frequency range. A microphone unit is coupled to the first speaker and the second speaker. The first speaker creates replacement sounds within the first frequency range that replicate sounds that are lost to the listener as a result of an occlusion effect at the second speaker. The replacement sounds are presented to the listener.

### CROSS REFERENCE TO RELATED APPLICATION

This patent claims benefit under 35 U.S.C. §119 (e) to U.S. Provisional Application No. 61/867,359 entitled “Dynamic Driver in Hearing Instrument” filed Aug. 19, 2013, the content of which is incorporated herein by reference in its entirety.

### TECHNICAL FIELD

This application relates to speakers, and, more specifically to speakers used in hearing instrument systems.

### BACKGROUND OF THE INVENTION

Hearing instruments are in common use today and usually include a microphone circuit, amplification circuit, and receiver (or speaker) circuit. The microphone circuit receives audio energy and then converts this audio energy into electrical signals. The electrical signals may, in turn, be amplified (or otherwise processed) by the amplification circuit and forwarded to the receiver. The receiver circuit may then convert the amplified signals into audio signals that the user of the hearing instrument can hear. Other electronic devices may also utilize the above-mentioned circuits. Receivers and speakers are useful in many listening devices such as earphones, headphones, Bluetooth wireless headsets, or the like.

General speaking, conventional receiver in canal (RIC) devices are designed to isolate the desired sound presented at the user's ear drum from other sounds and/or noise from the outside environment above a particular frequency (e.g., approximately 1 kHz). In this regard, previous insert earphones typically included a housing having a receiver mounted within the housing. A rigid ear tip surrounded the housing and engaged the walls of the ear canal. In these systems, the receiver was positioned near the entrance to the ear canal so that the user could receive the sound energy produced by the receiver.

Currently, hearing instrument users are attempting to extend the bandwidth of their instruments to improve the sound quality experienced by the end user. Unfortunately, several problems existed with the current approaches. Customers are expanding the frequency range in both low and high frequencies. A high frequency driver typically does not have sufficient output in low frequencies when in open fit applications. For low frequency operations, a seal is used for a balanced armature receiver to provide sufficient output to the user. However, when the ear is sealed, the user experiences poor sound quality due to occlusion. This has produced user dissatisfaction with these previous approaches.

### BRIEF DESCRIPTION OF THE DRAWINGS

For a more complete understanding of the disclosure, reference should be made to the following detailed description and accompanying drawings wherein:

FIG. 1 comprises a block diagram of an acoustic system that negates the effects of occlusion according to various embodiments of the present invention;

FIG. 2 comprises a graph of a system response showing the effects of implementing the approaches described herein according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

A system is provided whereby the occlusion that occurs in previous systems is compensated for and low frequency sounds that have been occluded are effectively replaced by a speaker. In other words, sounds that have been lost are reproduced and presented to the listener. Consequently, the negative effects associated with occlusion are greatly reduced or eliminated. Moreover, the approaches described herein are easy to use, cost effective to implement, and improve the quality of sound presented to the user.

In many of these embodiments, a system includes a microphone unit, a first speaker that has a first frequency range and a second speaker that has a second frequency range. The first speaker and the second speaker are coupled to the microphone unit. The second speaker, in one example, is disposed within an ear tip apparatus and the tip together with the second speaker are placed in the ear (e.g., in the ear canal) of the user. The ear tip apparatus has at least one channel passing there through. The first speaker replaces the sounds that are rolled off (i.e., caused to be lost) as a result of the open fit and the occlusion associated with the open fit. The first speaker is placed, for example, in the outer area of the ear. The sounds produced by the first speaker pass through the channels of the ear tip so that these sounds can be heard by the user.

In other aspects, a RIC device is coupled with a second dynamic driver which remains within the outer ear, to provide the low frequency energy to the ear drum (i.e., <approximately 1 kHz). This dynamic driver will not be sealed to the ear, thereby still giving relief from the occlusion effect. This dynamic driver may only be used in particular situations when there is a desire to provide amplified low frequency sound energy.

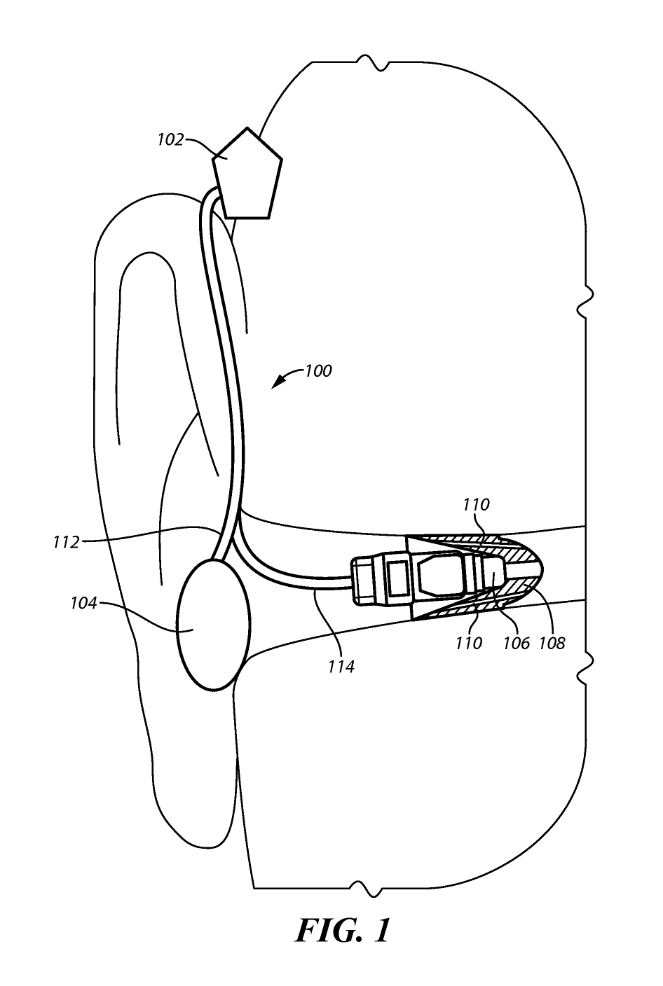

Referring now to FIG. 1, one example of a hearing instrument system that is configured to compensate for occlusion is described. The system 100 includes a microphone unit 102, a first speaker 104 (having a first frequency range) and a second speaker 106 (having a second frequency range). In one example, the first frequency range is 50-1.5 kHz and the second frequency range is 1.5 kHz 12 kHz. The first speaker and the second speaker are coupled to the microphone unit 102. Wires 112 provide a coupling between the microphone unit 102 and the first speaker 104. Wires 114 provide a coupling between the microphone unit 102 and the second speaker 106.

The microphone unit 102 is any microphone unit that receives sound energy and converts the sound energy into electrical signals. In this respect, a Microelectromechanical System (MEMS) microphone such as the MQM manufactured by Knowles Electronics, Inc. may be included in the microphone unit 102. As such, the MEMS microphone within the microphone unit 102 may include a diaphragm, a back plate, and a MEMS die, and operate as known to those skilled in the art. As shown, the microphone unit is a behind-the-ear (BTE) unit, but in other examples may be located at other places such as in-the-ear (ITE) or remote mic, in the outer ear.

The microphone unit 102 may also include and amplifier or other processing circuitry that processes the electrical signals created. Other examples of microphone units, microphones, and functions performed by the microphone unit are possible.

The first speaker 104 is disposed outside the tip 108 in the outer ear of the user. The second speaker 106 is disposed within the tip 108. The tip 108 is a compliant component for example, and includes channels 110 that pass through it. The ear tip 108 is configured to fit within the ear canal of a listener either partially or entirely. The speakers 104 and 106 convert the electrical signals into sound energy so that the user can hear the sound energy. In one example, the speaker 106 is a balanced armature speaker and the speaker 104 is a dynamic driver. The speaker 104 (that is located in the outer ear) is configured to produce sound energy in a predetermined frequency range such as 50 Hz-1.5 kHz. In this respect, the speaker 104 may be a woofer as known to those skilled in the art.

In operation, the first speaker 104 produces and ultimately replaces the sounds that are rolled off (or caused to be lost) as a result of the open fit of the ear tip 108. The lost sounds may be of a predetermined frequency range. The first speaker 104 is placed, for example, in the outer area of the ear. By outer area of the ear, it is meant a region including but not restricted to the concha. The sounds produced by the first speaker pass through the channels 110 of the ear tip 108 so that these sounds can be heard by the user. The channels 110 may be one or more holes, openings, or passageways having a predetermined diameter that extend completely through the ear tip 108 and thereby allow sounds to pass from the first speaker 104 to the ear canal of the listener so that these sounds can be heard by the listener.

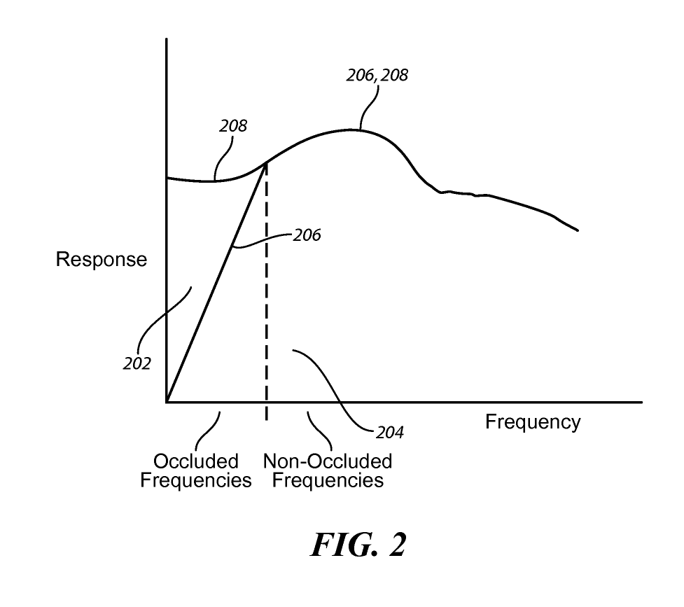

Referring now to FIG. 2, one example of the beneficial effects of the approaches described herein is described. As shown in FIG. 2, a first region 202 includes frequencies (indicated by the horizontal axis) that are lost due to occlusion and prevented by the effect from reaching the user. A second region 204, on the other hand includes frequencies that are not lost due to occlusion and, consequently, reach the user. Occlusion produces a response curve 206 as shown in FIG. 2.

However, the present approaches reintroduce frequencies in the first region 202 (that are lost when addressing occlusion due to open fit applications) by using a speaker (e.g., the speaker 104) that resides in the outer ear. Sounds of a predetermined frequency range are produced, pass through one or more openings in the ear tip, and reach the user. The effect of doing this makes yields the response 208. In this way, the negative effects of occlusion are negated or eliminated and the response of the system (the response heard by a listener) does not include missing frequencies.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A hearing instrument, the hearing instrument comprising:
a first speaker having a first frequency range;
a second speaker disposed in the ear of a listener, the second speaker having a second frequency range that is wider than the first frequency range;
a microphone unit coupled to the first speaker and the second speaker;
wherein the first speaker creates replacement sounds within the first frequency range that replicate sounds that are lost to the listener as a result of an occlusion effect at the second speaker, the replacement sounds from the first speaker being presented to the listener.

2. The hearing instrument of claim 1, wherein the replacement sounds are of a frequency range of less than 1 kHz.

3. The hearing instrument of claim 1, wherein the first speaker is positioned at an outer area of the ear.

4. The hearing instrument of claim 1, wherein the microphone unit comprises a microelectromechanical system (MEMS) microphone.

5. The hearing instrument of claim 1, wherein the microphone unit is a behind-the-ear (BTE) unit.

6. The hearing instrument of claim 1, wherein the microphone unit is a in-the-ear (ITE) unit.

7. The hearing instrument of claim 1, wherein the second speaker is disposed with an ear tip.

8. The hearing instrument of claim 7, wherein the ear tip comprises channels and the replacement sounds from the first speaker pass through channels of the ear tip to the listener.

9. The hearing instrument of claim 1, wherein the first speaker comprises a woofer.

10. A method of operating a hearing instrument, the method comprising:
coupling a first speaker and a second speaker to a microphone unit, the first speaker having a first frequency range and the second speaker having a second frequency range, the second frequency range being wider than the first frequency range;
at the second speaker, presenting a range of sounds to a listener at the second frequency range;
at the first speaker, creating replacement sounds within the first frequency range that replicate sounds that are lost at the second speaker due to occlusion, and presenting the replacement sounds to a listener.

11. The method of claim 10, wherein the replacement sounds have a frequency range of less than 1 kHz.

12. The method of claim 10, wherein the first speaker is disposed at an outer area of the ear.

13. The method of claim 10, wherein the microphone unit comprises a micro electro mechanical system (MEMS) microphone.

14. The method of claim 10, wherein the microphone unit is a behind-the-ear (BTE) unit.

15. The method of claim 10, wherein the microphone unit is a in-the-ear (ITE) unit.

16. The method of claim 10, wherein the second speaker is disposed with an ear tip.

17. The method of claim 16, wherein ear tip comprises channels, and the replacement sounds from the first speaker pass through channels of the ear tip to the listener.

18. The method of claim 10, wherein the first speaker comprises a woofer.
